(19) United States
(12) Patent Application Publication
(10) Pub. No.: US 2026/0227341 A1
(43) Pub. Date: Aug. 6, 2026

(54) DEVICE FOR INSPECTING A PLANAR OR WEB-SHAPED OBJECT

(71) Applicant: ISRA VISION GmbH, Darmstadt (DE)

(72) Inventors: Tunahan DEMIRCI, Oberhausen (DE); Josef DROSTE, Glandorf (DE); Stefan TASSE, Schermbeck (DE)

(21) Appl. No.: 19/151,124

(22) PCT Filed: Feb. 9, 2024
(86) PCT No.: PCT/EP2024/053277

§ 371 Date: Jul. 25, 2025

(30) Foreign Application Priority Data
Feb. 14, 2023 (DE) 10 2023 103 520.7

(51) Int. Cl. G01N 21/89; G01N 21/01; G01N 21/88; G01N 21/896

(52) U.S. Cl. CPC G01N 21/8901; G01N 21/01; G01N 21/896; G01N 2021/8822; G01N 2021/8909

(57) ABSTRACT

A device and a corresponding method for inspecting a web-shaped or planar object. The device includes a vibration generator and an optical sensor and, if necessary, a corresponding illumination apparatus. In order to avoid contamination or mechanical damage to the object and at the same time to enable precise optical inspection of the object, the vibration generator forms a plane levitation surface on a side facing the object, over which the object is movable in suspension substantially parallel to the levitation surface. The vibration generator is formed in one piece and has at least one through-going vibration generator, the levitation surface cutting through in such a way that the object is inspectable by the optical sensor arranged on the object-distant side of the vibration generator facing away from the object or by the illumination apparatus arranged on the side of the vibration generator facing away from the object.

### DESCRIPTION

The invention relates to a device for inspecting a plate-shaped or web-shaped object having a top side and a bottom side, for example a thin glass pane, a thin plastic film, wafer or the like, by means of an optical sensor.

For an inspection, a thin plate-shaped or web-shaped object is usually conveyed on a conveyor belt and illuminated on the top side and/or the bottom side by means of an illumination device. An optical sensor, for example a camera, captures the electromagnetic radiation transmitted by the object and/or reflected by the object. Based on these measurement results, the quality of the object may be evaluated and/or the dimensions of the object determined.

In the case of ultra-thin plate-shaped or web-shaped objects, e.g. glass panes for cell phones, or plastic films, mechanical damage or contamination may easily occur during conveying on a conveyor belt if the bottom side of the object rests on the belt. To avoid this, a sonotrode with a sound-emitting surface facing the object may be used. Such a sonotrode is described, for example, in documents WO 2015/010681 A2 and WO 2009/056127A2. The inspection device disclosed in document WO 2009/056127 A2 comprises a vibration generator with a carrier body made of a translucent material. Because of this, the bottom side of the material to be inspected can be observed by means of an optical sensor through the carrier body, which is arranged below the carrier body. However, this procedure is not advantageous for ultra-thin plate-shaped or web-shaped objects, as the carrier body influences the measurement result and reduces its accuracy.

The object is therefore to create a device or specify a method that enables accurate optical inspection of a thin plate-shaped or web-shaped object while avoiding mechanical damage or contamination.

The above object is solved by a device with the features of claim 1 and a method with the features of claim 9.

In particular, the object is solved by a device for inspecting a web-shaped or plate-shaped object with a top side and a bottom side, wherein the device comprises a vibration generator and an optical sensor as well as a corresponding illumination device, wherein the vibration generator forms a plane levitation surface on a side facing the object, over which the object is movable from a first end to a second end by means of a conveying device, wherein the vibration frequency and the vibration amplitude of the vibration generator are adjustable such that the object is substantially parallel to the levitation surface, that the object is movable in suspension substantially parallel to the levitation surface, wherein the object is inspectable by means of the illumination device and the optical sensor, wherein the vibration generator is formed in one piece and comprises at least one through-going gap partially cutting through the levitation surface in such a way that the object is inspectable directly through the gap by means of the optical sensor arranged on the side of the vibration generator facing away from the object and/or is illuminatable directly through the gap by means of the illumination device arranged on the side of the vibration generator facing away from the object. In the first case, the electromagnetic radiation reflected or transmitted by the object passes through the gap to the optical sensor, which receives the respective electromagnetic radiation. In the second case, the electromagnetic radiation generated by the illumination device reaches the object through the gap.

The web-shaped or plate-shaped object to be inspected may be a thin or ultra-thin glass pane (e.g. for a cell phone), wafers, microchips or a thin film, wherein the object may be formed to be at least partially transparent to electromagnetic radiation. The two opposite largest sides of the object are referred to as the top side and the bottom side, wherein the side of the object facing the vibration generator forms the bottom side and the opposite side of the object forms the top side. The thickness of such an object, which is measured between the top side and the bottom side of the object, is in the range of 0.03 mm to 1 mm, for example.

The vibration generator (also known as the sonotrode) is designed in such a way that it forms a plane levitation surface. The vibration generator may comprise a cuboid shape or a cuboid-like shape, for example. The bottom side of the object faces the levitation surface and is conveyed along it from a first end to a second end of the levitation surface. The direction of conveying along the levitation surface is referred to below as the conveying direction. The vibration frequency and the vibration amplitude of the vibration generator can be adjusted in such a way that a standing (stationary) pressure wave is generated in the air film arranged underneath the object, so that the object floats essentially parallel to the levitation surface and thereby moves in the conveying direction by means of the conveying device. For example, the vibration generator has dimensions in the range of 0.4 m to 3 m in length and 10 cm to 40 cm in width, wherein, for example, the levitation surface has a size in the range of 400 cm² to 12,000 cm². The frequency of the vibration generator is, for example, in the range of 10 kHz to 50 kHz, in particular in the range of 30 kHz to 40 kHz, and the amplitude is, for example, in the range of 1 μm to 50 μm. The vibration generator may be, for example, attached to profile elements (e.g. aluminum profile elements) for optimum generation of the vibration, namely in such a way that it is only attached to the respective profile element at the nodal points of the vibration of the vibration generator, e.g. by means of screws.

An optical sensor, for example a high-resolution line scan or matrix camera, is provided for optical inspection of the object in order to observe the electromagnetic radiation reflected and/or transmitted by the object in bright field or dark field. Accordingly, the illumination device may be designed as a line-shaped or matrix-shaped illumination device, for example as a line or matrix with a large number of LEDs. By means of the illumination device, the object is illuminated in a predetermined area, wherein the illumination device generates electromagnetic radiation in the wavelength range suitable for the respective examination. In one embodiment, the optical sensor is arranged above the top side of the object. For the examination of the object with regard to the transparency properties, the illumination device is arranged on the side of the vibration generator facing away from the object and illuminates the bottom side of the object through the gap. Alternatively, conversely, the illumination device for illuminating the top side of the object may be arranged above the object and the optical sensor below the side of the vibration generator facing away from the object. To examine the properties in reflection on the bottom side of the object, both the illumination device and the optical sensor may be arranged below the side of the vibration generator facing away from the object. In this case, the electromagnetic radiation emitted by the illumination device passes through the gap directly to the bottom side of the object. The electromagnetic radiation then reflected by the object is also passed through the gap directly to the optical sensor. Similarly, it is possible to arrange the optical sensor and the illumination device above the top side of the object in order to examine the top side of the object in reflection. Combinations of the above illumination and capturing configurations for the transmitted and/or reflected electromagnetic radiation are particularly advantageous. In addition, the illumination angle of the illumination device may be adjusted and varied accordingly to allow an analysis of the bright field or dark-field properties of the object. For example, a single optical sensor may be arranged above the top side of the object and at least one illumination device above the top side of the object and at least one illumination device below the side of the vibration generator facing away from the object. This may allow the reflection and transmission of the electromagnetic radiation to be observed, for example in bright field, by means of the optical sensor. With a second illumination device, which is also arranged above the top side of the object at an angle different from the illumination angle of the first illumination device, the dark-field reflection may also be measured. In such a configuration with two or more than two illumination devices and a single associated optical sensor, which captures the signals generated by several illumination devices (and the object), it is advantageous to separate the signals in terms of time and/or the wavelength. In the case of temporal separation, the illumination devices may be switched on and off again temporally successively in such a way that the illumination is only provided by a single illumination device at any given time. The signals captured by the optical sensor can be assigned to the respective illumination signal accordingly, as they are generated directly in transmission and reflection on the object, based on their measurement period. Additionally or alternatively, the illumination may take place in different wavelength ranges so that the signals captured by the optical sensor may be differentiated with regard to the respective wavelength range. For example, a first illumination device may generate electromagnetic radiation in the wavelength range 400 nm to 500 nm for illumination with a visible blue-green color and a second illumination device may generate electromagnetic radiation in the wavelength range 600 nm to 700 nm for illumination with a visible red color.

The position and orientation of the optical sensor and the at least one illumination device in the surrounding space, in particular in relation to the reflective surface, is known. The position and orientation of the optical sensor may be determined using a known calibration method.

The optical sensor in the form of a line scan or matrix camera determines a brightness value and/or a color value for each pixel of an observed area of the object. In one embodiment, the color and/or brightness values of all areas of the object may be combined to form an image. The color and/or brightness values may be forwarded to the data processing unit where they are analyzed for defects and/or contamination. In one embodiment, by moving the object along the levitation surface and thus transversely to the optical sensor, which is fixed with respect to the levitation surface at least during the inspection, the object may be inspected over its entire top and/or bottom side. Alternatively, proportions of the top and/or bottom side of the object may be analyzed.

The data processing unit may be integrated into the optical sensor as a module or form a unit separate from the optical sensor. In the latter case, the image data is transmitted by wire or radio from the camera to the data processing unit. The data processing unit comprises a processor, which is a functional module that interprets and executes instructions/commands of an algorithm as well as an instruction control unit, an arithmetic unit and a logic unit. The processor may comprise at least a microprocessor, a digital signal processor (DSP), an application specific integrated circuit (ASIC), a field programmable gate array (FPGA—digital integrated circuit into which a logic circuit can be programmed), a discrete logic circuit and any combination of these. The data processing unit may also comprise a memory module, an input module (e.g. keyboard or touchpad), a power supply module (e.g. battery) and a display module (e.g. display). The data processing unit may be formed as a real hardware resource, for example a smartphone, desktop computer, server, notebook, cluster/warehouse scale computer, embedded system or the like, or as a virtualized computer resource. The data processing unit may also comprise a transmitter/receiver (transceiver) for exchanging data with the optical sensor.

Using the optical data (e.g. intensity and/or color data) detected by the optical sensor in relation to the electromagnetic radiation transmitted and/or reflected by the object in bright-field and/or dark-field, it is possible to detect contamination and/or defects of the object during the inspection and to assign these to a specific position or area of the object. Contamination and/or defects are, for example, particles, scratches, stains/discolorations, protrusions, indentations, dents, bubbles, material compaction, burrs, rings and the like arranged on the top side and/or bottom side of the object or in the object volume. Such contamination and/or defects are detected, for example, by a change in contrast and/or brightness in the reflected and/or transmitted electromagnetic radiation. For this purpose, the signal captured and possibly digitized by the optical sensor is transmitted to a corresponding data processing unit for evaluation and determination of the contamination and/or defects. Based on the conveying speed of the object and the known location of the arrangement of the illumination device and optical sensor, the position or the area of the detected defect and/or contamination may also be determined from the signal captured by the optical sensor and the associated measurement time. Contamination and/or defects may also be detected, for example, by measuring the deflection or a variation of the deflection of the electromagnetic radiation reflected and/or transmitted by the material of the object. This is possible, for example, using methods described in more detail in document EP 2 390 656B1. The content of the method described there is incorporated by reference herein.

According to the invention, the vibration generator is formed in one piece and comprises at least one through-going gap partially cutting through the levitation surface in such a way that the object is directly inspectable through the gap by means of the optical sensor arranged on the side of the vibration generator facing away from the object and/or directly illuminatable through the gap by means of the illumination device arranged on the side of the vibration generator facing away from the object. The gap thus allows a direct determination of the transmission properties or the reflection properties on the bottom side of the object, wherein the electromagnetic radiation transmitted or reflected by the object passes through the gap directly to the optical sensor. The illumination of the bottom side of the object by means of the illumination device arranged on the side of the vibration generator facing away from the object is also provided directly through the gap. This prevents the signal from being altered by another material (e.g. the material of the vibration generator). This raises the accuracy of the optical inspection. In addition, the one-piece form of the vibration generator ensures that it vibrates in the same way on both sides of the gap, so that the standing (stationary) wave that causes the levitation is generated evenly over the entire levitation surface and thus the levitation of the object can be reliably achieved in order to counteract mechanical damage to the sensitive object or contamination. The one-piece form of the vibration generator also avoids time-consuming adjustment, which would be necessary if two separate sonotrodes were used. In addition, the one-piece form of the vibration generator ensures that the vibration is in phase over the entire surface of the vibration generator. The distance between the bottom side of the object and the levitation surface caused by the levitation is, for example, 20 μm to 100 μm.

In one embodiment, the vibration generator may comprise a single one of such gap, alternatively the vibration generator comprises two or more than two such gaps, wherein in one embodiment at least two gaps run parallel or at a predetermined angle to each other. The at least one gap may comprise a rounded edge at the front edge in the conveying direction, which is advantageous because this prevents an object that may be sagging from getting stuck on the gap during conveying.

The gap is formed in such a way that it passes through the vibration generator and partially cuts through the levitation surface so that electromagnetic radiation passes through the gap on its way from an illumination device to the object or from the object to the optical sensor, respectively depending on the configuration of the device. Accordingly, the illumination device and/or the optical sensor are oriented in such a way that the electromagnetic radiation passes from the illumination device via the gap to the object or from the object via the gap into the optical sensor. The gap is formed in the shape of a slit, for example, so that only a line-shaped area of the object is illuminated or the reflected or transmitted electromagnetic radiation is recorded by a line-shaped area of the object. The gap extends, for example, with its largest dimension (referred to as length) transverse, e.g. perpendicular, to the conveying direction of the object across the levitation surface, wherein in one embodiment the length of the gap transverse to the conveying direction is equal to or greater than the width of the object. For example, the length of the gap in the area of the levitation surface is equal to or greater than 10 cm. For example, the width of the gap in the area of the levitation surface is equal to or greater than 0.5 mm, e.g. equal to or greater than 1 mm, wherein the width of the gap is measured perpendicular to the length of the gap. If the gap runs perpendicular to the conveying direction, then the width of the gap is measured in the conveying direction. In one embodiment, the width of the gap in the area of the levitation surface is less than 5 mm, as otherwise the object in the section located above the gap would be deformed too much (e.g. bent in the direction of the gap) due to its own mass. Since the gap only partially cuts through the levitation surface, the levitation surface comprises a web at least at one end of the gap (in the direction of the length of the gap), via which the body sections of the vibration generator, which are arranged in front of and behind the gap in the conveying direction, are connected to each other. Such a web (hereinafter also referred to as a bridging/connecting web) may also be arranged at both ends of the gap. The respective web forms a rigid connection between the body sections of the vibration generator and ensures that all body sections of the vibration generator vibrate in the same way, thus ensuring a reliable and uniform formation of the standing wave and thus the conveying of the object. In one embodiment, the connecting web may comprise a width (shortest dimension between the end of the gap and the edge of the vibration generator in the area of the levitation surface) of at least 20 mm (for example at least 10% of the length of the gap defined above) along the levitation surface, so that a reliably rigid connection of the body sections of the vibration generator is achieved.

In one embodiment, the width of the at least one gap of the vibration generator at the first gap end located at the levitation surface is smaller than the width of the gap at the second gap end located at the side of the vibration generator opposite the levitation surface. On the one hand, this may keep the gap size in the area of the levitation surface small, so that the deformation of the object in the area of the gap is very small. On the other hand, such an approximately wedge-shaped design of the gap, for example, makes it possible that different illumination and/or observation directions (i.e. the direction of the corresponding illumination or inspection axis) of the illumination device or the optical sensor, which are arranged on the side of the vibration generator facing away from the object, may be used at a predetermined angle oblique to the levitation surface. In this embodiment, the gap is formed, for example, in such a way that the gap comprises a trapezoidal shape in a cross-section along the conveying direction of the object. The parallel base sides of the trapezoid form the opening/width of the gap in the area of the levitation surface and in the area of the side of the vibration generator facing away from the object, wherein the opening/width in the area of the levitation surface is smaller than in the area of the side of the vibration generator facing away from the object. As already partially explained above, the width of the gap in the area of the levitation surface is, for example, 0.5 mm≤width (in the area of the levitation surface)≤10 mm, in particular 0.5 mm≤width (in the area of the levitation surface)≤5 mm, in the area of the side of the vibration generator facing away from the object, for example, in the range 5 mm≤width (on the side facing away from the object)≤25 mm. The dimension (thickness) of the vibration generator in a direction perpendicular to the levitation surface is, for example, in the range 5 mm≤thickness≤30 mm.

In one embodiment, the levitation surface of the vibration generator is arranged inclined with respect to the direction of the gravitational force by a maximum of 65°, for example inclined by at least 15°, in such a way that the conveying of the object from the first end to the second end of the levitation surface takes place continuously at this angle transverse to the direction of the gravitational force, wherein the conveying device is provided at the lower end of the inclined levitation surface of the vibration generator. In one embodiment, the optical sensor and the illumination device are arranged such that the inspection axis (optical axis) of the optical sensor and the illumination axis of the electromagnetic radiation of the illumination device are arranged correspondingly inclined to the direction of the gravitational force. The conveying device may be formed as a conveyor belt. For example, the conveying device comprises a conveyor belt or at least two conveyor belts, each having a belt surface running transversely to the levitation surface of the vibration generator and a circumferential belt surface moving on the top side in the conveying direction, for example perpendicular to the inclined levitation surface, wherein, when at least two conveyor belts are used, a first conveyor belt is arranged in the area between the first end of the levitation surface and the at least one gap and a second conveyor belt is arranged in the area between the at least one gap and the second end of the levitation surface. In the presence of several gaps in the vibration generator, such a conveyor belt may also be arranged between two adjacent gaps. The conveyor belt enables simple and cost-effective movement of the object along the levitation surface in such a way that the entire object is inspected by the inspection device. The lower edge of the object rests on the respective conveyor belt. The inclined arrangement of the object on the conveying device prevents slippage during conveying and thus further raises the accuracy of the inspection. The use of several conveyor belts, which are arranged on both sides of the respective gap, is advantageous because in this case the illumination or observation of the object is not impaired by the conveyor belts. In one embodiment, the conveying device, for example the conveyor belt, is arranged in a corresponding cut-out, for example a lowered edge of the vibration generator.

In one embodiment, the inspection axis of the optical sensor or the illumination axis of the illumination device runs at an angle to the surface normal of the levitation surface that is greater than or equal to 5°. This is particularly advantageous if the properties of the object are to be analyzed with a single optical sensor not only in bright-field but also in dark-field.

In one embodiment, the elements of the inspection device explained above may be attached to a frame.

In one embodiment, a suction device is provided which extracts gas (e.g. air) from the space between the bottom side of the object and the levitation surface, essentially in the direction of the levitation surface. For this purpose, small, through-going through the vibration generator in a direction perpendicular or oblique to the levitation surface, openings (e.g. holes, diameter for example in the range of 1 mm to 5 mm) may be provided in the vibration generator, which are in fluid connection with a suction pump for the gas (suction pressure for example in the range of 1 mbar to 100 mbar). The suction direction thus runs approximately in the opposite direction or at an angle in relation to the direction of levitation. A suction device of this type may be used to prevent deformation due to the levitation movement in the case of objects with a particularly low thickness (thickness e.g. in the range of 0.03 mm to 0.25 mm).

The above object is also solved by a method for inspecting a web-shaped or plate-shaped object with a top side and a bottom side, wherein the device comprises a vibration generator and an optical sensor as well as a corresponding illumination device, wherein the vibration generator forms a plane levitation surface on a side facing the object, wherein the vibration generator is formed in one piece and comprises at least one through-going gap partially cutting through the levitation surface, with the following steps:
moving the object by means of a conveying device from a first end to a second end of the levitation surface, wherein the vibration frequency and the vibration amplitude of the vibration generator are set such that the object is movable in suspension substantially parallel to the levitation surface, and
inspecting the object by means of the illumination device and the optical sensor, which comprises directly inspecting the object through the gap by means of the optical sensor arranged on the side of the vibration generator facing away from the object and/or directly illuminating the object through the gap by means of the illumination device arranged on the side of the vibration generator facing away from the object.

The method comprises the advantages and embodiments explained above in relation to the device (each as a method), so reference is made to the above discussion of the invention.

In particular, in one embodiment of the method, it is advantageous if the object is conveyed from the first end to the second end of the levitation surface transversely to the direction of the gravitational force via the levitation surface of the vibration generator, which is arranged inclined by a maximum of 65° with respect to the direction of the gravitational force, by means of the conveying device provided at the lower end of the inclined levitation surface of the vibration generator.

In one embodiment of the method, the object is conveyed by means of the conveying device comprising at least two conveyor belts each having a belt surface running transversely to the levitation surface of the vibration generator, wherein a first conveyor belt is arranged in the area between the first end of the levitation surface and the at least one gap and a second conveyor belt is arranged in the area between the at least one gap and the second end of the levitation surface. In one embodiment of the method, the object is inspected such that the inspection axis of the optical sensor or the illumination axis of the illumination device runs at an angle to the surface normal of the levitation surface that is greater than or equal to 5°.

In one embodiment of the method, the inspection includes an evaluation of the electromagnetic radiation captured by the optical sensor and transmitted through the object and/or the electromagnetic radiation captured by the optical sensor and reflected from the object, e.g. an evaluation of the electromagnetic radiation reflected or transmitted by bright-field illumination or dark-field illumination and received by the optical sensor with regard to the presence of defects and/or irregularities such as inclusions, scratches, contamination, etc. present in the object at the respective location, i.e. on the surface or in the bulk.

In one embodiment of the method, the inspection includes bright-field illumination and/or dark-field illumination.

The electromagnetic radiation used for the inspection is, for example, electromagnetic radiation from the visible wavelength range (wavelength in the range 380 nm to 780 nm) or from the infrared radiation range (wavelength greater than 780 nm) and/or from the UV radiation range (wavelength less than 380 nm). The electromagnetic radiation used in each case may contain individual sections of these wavelength ranges or combinations of several sections.

In one embodiment, the vibration generator comprises at least one material of the group comprising aluminum, aluminum alloy and glass or consists of at least one material of this group.

In one embodiment, as described above, gas (e.g., air) is exhausted from the space between the bottom side of the object and the levitation surface substantially in the direction of the levitation surface.

Further advantages, features and possible applications of the present invention are also apparent from the following description of an embodiment and the drawings. All the features described and/or illustrated form the object of the invention, either individually or in any combination, even independently of their summary in the claims or their references.

The following shows schematically

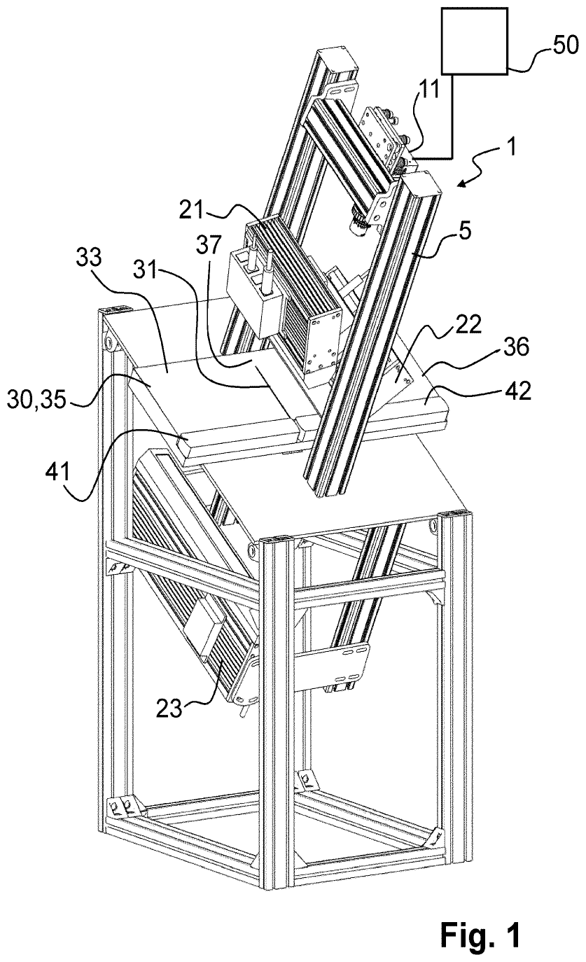

FIG. 1 a perspective side view of an embodiment of an inspection device according to the invention,

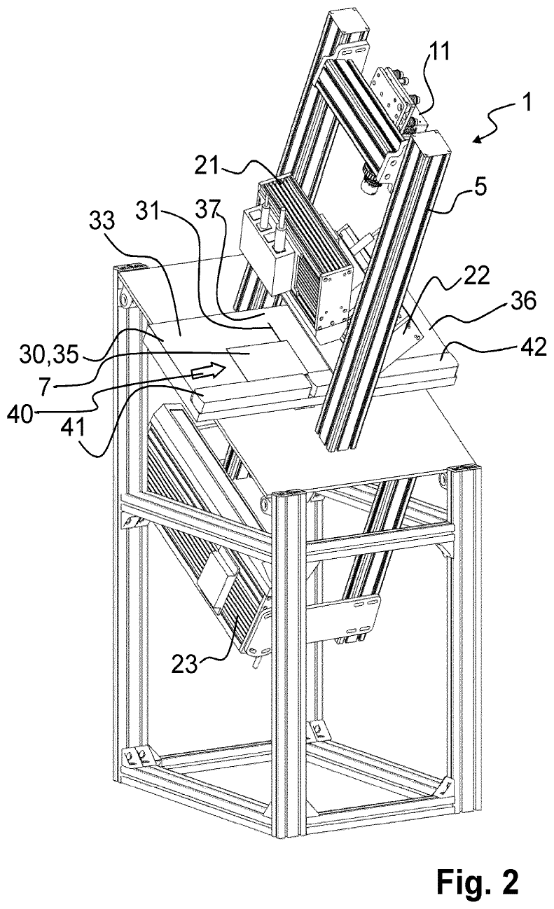

FIG. 2 a perspective side view of the embodiment according to FIG. 1 with an object,

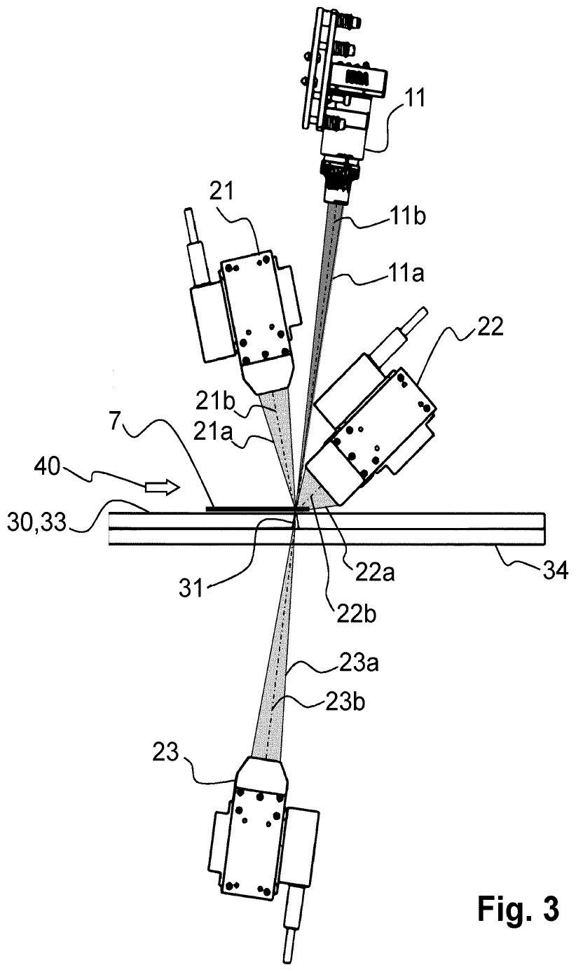

FIG. 3 a front view of a principle sketch of the embodiment according to FIG. 1,

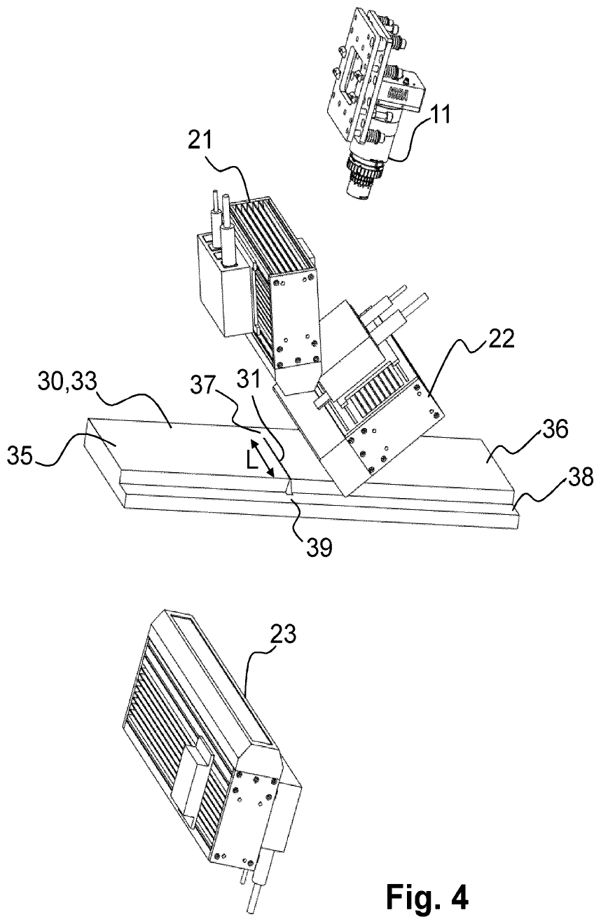

FIG. 4 a perspective side view of the elements of the embodiment according to FIG. 1 necessary for the optical inspection of the object,

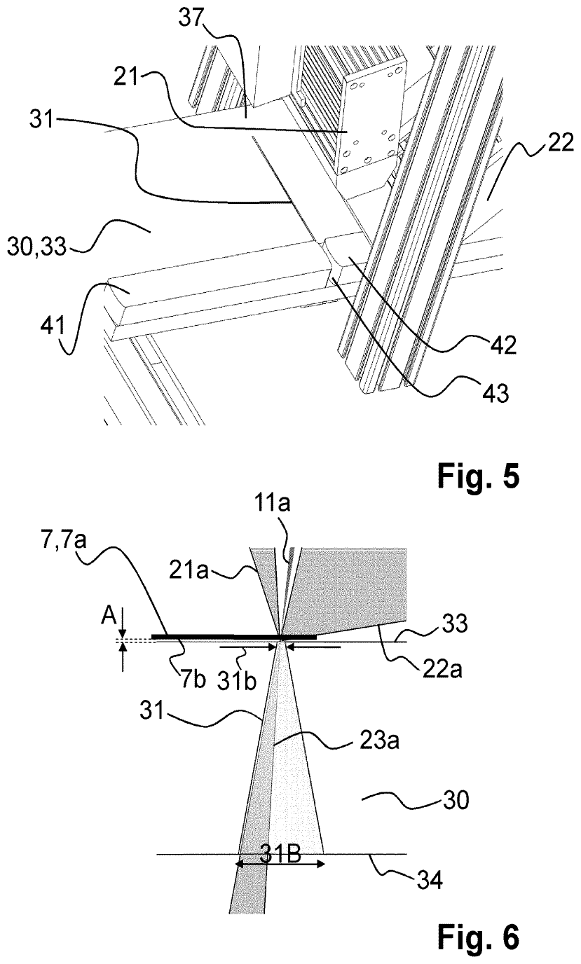

FIG. 5 an enlarged section of FIG. 1 and

FIG. 6 an enlarged section of FIG. 3 in the area of the gap.

FIGS. 1 to 6 show an embodiment of an inspection device 1 according to the invention in various views and as a principle sketch, which also illustrates the electromagnetic radiation path.

An optical sensor in the form of a line scan camera (in short: camera 11) as well as a first illumination device 21, a second illumination device 22 and a third illumination device 23 are attached to a frame 5 of the inspection device 1. Furthermore, a vibration generator (sonotrode 30) with a gap 31 is provided, over the top, plane levitation surface 33 of which an object (here thin glass pane 7) is conveyed from a first end 35 to a second end 36 of the levitation surface 33. The sonotrode 30 is mounted on aluminum profiles. The sonotrode 30 is formed in one piece, for example as an aluminum block.

The sonotrode 30 is operated at a frequency of 30 to 40 kHz and an amplitude of 1 μm to 10 μm in order to convey the glass pane 7 with dimensions of 200 mm×300 mm in a floating manner from the first end 35 to the second end 36 of the levitation surface 33. The distance A (see FIG. 6) between the bottom side of the glass pane 7 and the levitation surface 33 is, for example, 20 μm to 100 μm. The aforementioned movement of the glass pane 7 is effected by conveyor belts 41, 42, which are arranged on both sides of the gap 31 of the sonotrode 30 in a recess 38 of the sonotrode. The glass pane 7 rests with its lower edge on the top side of the respective conveyor belt 41, 42 and is conveyed in the conveying direction (arrow 40, see FIGS. 2 and 3) by means of the respective conveyor belt 41, 42. Each conveyor belt 41 comprises a circumferential belt, the surface of which is formed from plastic material, for example.

The gap 31 arranged in the central area of the sonotrode 30 runs perpendicular to the conveying direction (arrow 40) and extends from the levitation surface 33 through the entire sonotrode 30 to the side 34 of the sonotrode 30 facing away from the glass pane 7 (side 34 is opposite the levitation surface 33). As a result, the third illumination device 23 arranged below the sonotrode (i.e. below the side 34 of the sonotrode 30 facing away from the glass pane 7) may directly illuminate the glass pane 7 through the gap 31 (see FIGS. 3 and 6). However, the gap 31 does not cut through the levitation surface 33 over its entire width, as can be seen from FIGS. 1, 2, 4 and 5, but the sections of the sonotrode 30 located in front of and behind the gap 31 in the conveying direction are connected to one another by means of the rigid webs 37 and 39, so that the sections of the sonotrode 30 located in front of and behind the gap 31 oscillate with the same frequency, amplitude and phase. Therefore, the standing wave above the levitation surface 33 forms uniformly across the gap 31 and ensures that the glass pane 7 may be moved uniformly across the levitation surface 33 and does not deform in the area of the gap 31. For example, the gap has a trapezoidal shape in cross-section as shown in FIG. 6, which extends in the conveying direction (arrow 40). In the area of the levitation surface 33, the gap comprises, for example, a width 31b of 2 mm and in the area of the side opposite the glass pane 7 or the levitation surface 33, a width 31B of, for example, 9 mm. Furthermore, the gap 31 has a dimension of, for example, L=200 mm along its large dimension (length) transverse to the conveying direction. The length L of the gap 31 is usually greater than the width of the glass pane 7, which is measured transversely to the conveying direction or on the top side of the glass pane 7. The gap 31 comprises lateral surfaces running at a predetermined angle, which allow the electromagnetic radiation generated by the illumination devices to strike the glass pane 7 at a small angle (e.g. at least 5°) to the normal on the bottom side of the glass pane 7.

The optical components of the inspection device 1 are arranged such that the first illumination device 21 generates electromagnetic radiation 21a, which directly illuminates a line-shaped area of the top side of the glass pane 7. The electromagnetic radiation 21 falls, for example, at an angle of 10° (see angle of the illumination axis 21b, measured in relation to the normal on the top side of the glass pane 7). The electromagnetic radiation reflected by the glass pane 7 is reflected (along the beam 11a with the axis 11b) to the camera 11 and recorded by the camera 11 (bright-field measurement).

Further, the second illumination device 22 is arranged above the glass pane 7 and illuminates the glass pane 7 directly in a line-shaped area along the beam 22a at a second angle of 10° (see angle of the illumination axis 22b). The camera 11 observes the glass pane 7 under dark-field conditions in relation to the last-mentioned illumination along the beam 11a with the axis 11b. Finally, the third illumination device 23 is arranged below the side 34 of the sonotrode 30. As already explained above, the third illumination device 23 illuminates the bottom side of the glass pane 7 in a line-shaped area with electromagnetic radiation along the beam 23a with the illumination axis 23b. This radiation passes through the gap 31 directly to the bottom side of the glass pane 7, is at least partially transmitted through the glass pane and is observed along the beam 11a by means of the camera 11 after it emerges from the glass pane 7. The electromagnetic radiation may in each case include radiation from the visible wavelength range, for example, and the illumination devices 21, 22, 23 may be switched on successively and individually for a predetermined time, so that the camera 11 may successively record the respective resulting reflected or transmitted electromagnetic radiation and separate them from one another. The separation may also be performed by means of the respective wavelength range of the electromagnetic radiation used (as described above).

The illumination devices 21, 22, 23 are each formed as line-shaped illumination devices that illuminate the glass pane 7 in a line-shaped area across its entire width. For this purpose, they each comprise a row of LEDs, for example. The camera 11 is formed as a line scan camera, for example, which captures the reflected or transmitted electromagnetic radiation of the respective illuminated line-shaped area across the entire width of the glass pane 7. Each pixel of the line scan camera detects a color and/or a brightness signal, which are then transmitted to a data processing unit 50 for evaluation with regard to the presence of defects or contamination on the surface or in the volume of the glass pane 7. The data processing unit 50 may combine the individually captured brightness and/or color values of the line-shaped areas of the glass pane 7 to form an image of the glass pane 7 and may correlate/coordinate the measured values with the movement of the glass pane 7, so that the location/area of any detected defects and/or contamination on/in the glass pane 7 may be determined.

As can be seen in particular from FIGS. 1 and 2, the levitation surface 33 is inclined to the direction of the gravitational force (vertical in FIGS. 1 and 2). For example, the levitation surface 33 forms an angle of α=30° with the direction of the gravitational force (see FIG. 1). The upper surface of the two conveyor belts 41, 42, on which the glass pane 7 rests with its lower edge, extends perpendicular to the levitation surface 33. The inclined arrangement and the described arrangement of the conveyor belts 41, 42 prevent slippage between the glass pane 7 and the respective conveyor belt 41, 42. A gap 43 is formed between the conveyor belts 41, 42 in the area of the slot 31, which ensures that the conveyor belts 41, 42 do not obstruct the optical inspection of the glass pane 7.

Overall, the inspection device described above allows easy and accurate optical inspection of ultra-thin objects, which may be moved with respect to the optical components in such a way that they are not scratched or contaminated.

1. A device for inspecting a web-shaped or plate-shaped object having a top side and a bottom side, the device comprising:
a vibration generator;
an optical sensor; and
a corresponding illumination device,
wherein the vibration generator forms a plane levitation surface on a side facing the object over which the object is movable from a first end to a second end by a conveying device,
wherein vibration frequency and vibration amplitude of the vibration generator are adjustable in such a way that the object is movable in suspension substantially parallel to the levitation surface,
wherein the object is inspectable by the illumination device and the optical sensor, and
wherein the vibration generator is formed in one piece and comprises at least one through-going gap partially cutting through the levitation surface in such a way that the object can be inspected directly through the gap by the optical sensor arranged on the side of the vibration generator facing away from the object and/or can be illuminated directly through the gap by the illumination device arranged on the side of the vibration generator facing away from the object.

2. The device according to claim 1, wherein the levitation surface of the vibration generator is arranged inclined by a maximum of 65° with respect to the direction of the gravitational force in such a way that the object is conveyed from the first end to the second end of the levitation surface transversely to the direction of the gravitational force, and wherein the conveying device is provided at the lower end of the inclined levitation surface of the vibration generator.

3. The device according to claim 1, wherein the conveying device comprises at least two conveyor belts, each having a belt surface running transversely to the levitation surface of the vibration generator and wherein a first conveyor belt is arranged in the area between the first end of the levitation surface and the at least one gap and a second conveyor belt is arranged in the area between the at least one gap and the second end of the levitation surface.

4. The device according to claim 1, wherein the width of the at least one gap of the vibration generator at the first gap end located at the levitation surface is smaller than the width of the respective gap at the second gap end, which is located at the side of the vibration generator facing away from the object.

5. The device according to claim 1, wherein the gap comprises a trapezoidal shape in a cross-section along the conveying direction of the object.

6. The device according to claim 1, wherein the inspection axis of the optical sensor or the illumination axis of the illumination device runs at an angle to the surface normal of the levitation surface which is greater than or equal to 5°.

7. The device according to claim 1, wherein the optical sensor is a line scan camera and/or the illumination device is a line-shaped illumination device.

8. The device according to claim 1, wherein a suction device is provided which extracts gas from the space between the bottom side of the object and the levitation surface substantially in the direction of the levitation surface.

9. A method for inspecting a web-shaped or plate-shaped object having a top side and a bottom side, wherein a device comprises a vibration generator and an optical sensor as well as a corresponding illumination device wherein the vibration generator forms a plane levitation surface on a side facing the object, wherein the vibration generator is formed in one piece and comprises at least one through-going gap partially cutting through the levitation surface, the method comprising:
moving the object by a conveying device from a first end to a second end of the levitation surface, wherein vibration frequency and vibration amplitude of the vibration generator are set such that the object is movable in suspension substantially parallel to the levitation surface, and
inspecting the object by the illumination device and the optical sensor which comprises directly inspecting the object through the gap by the optical sensor arranged on the side of the vibration generator facing away from the object and/or directly illuminating the object through the gap by the illumination device arranged on the side of the vibration generator facing away from the object.

10. The method according to claim 9, wherein the object is conveyed from the first end to the second end of the levitation surface transversely to the direction of the gravitational force via the levitation surface of the vibration generator which is arranged inclined by a maximum of 65° with respect to the direction of the gravitational force, by the conveying device provided at the lower end of the inclined levitation surface of the vibration generator.

11. The method according to claim 9, wherein the conveying is carried out by the conveying device comprising at least two conveyor belts each having a belt surface running transversely to the levitation surface of the vibration generator, and wherein a first conveyor belt is arranged in the area between the first end of the levitation surface and the at least one gap and a second conveyor belt is arranged in the area between the at least one gap and the second end of the levitation surface.

12. The method according to claim 9, wherein the object is inspected such that the inspection axis of the optical sensor or the illumination axis of the illumination device runs at an angle to the surface normal of the levitation surface that is greater than or equal to 5°.

13. The method according to claim 9, wherein the inspection includes an evaluation of the captured electromagnetic radiation transmitted through the object and/or the captured electromagnetic radiation reflected from the object.

14. The method according to claim 9, wherein the inspection comprises bright-field illumination and/or dark-field illumination.

15. The method according to claim 9, wherein gas is sucked out of the space between the bottom side of the object and the levitation surface substantially in the direction of the levitation surface.
